(19) United States
(12) Patent Application Publication
(10) Pub. No.: US 2015/0361699 A1
(43) Pub. Date: Dec. 17, 2015

(54) Shell Having At Least Two Elements, Which Totally Encloses A Hinge For Furniture

(71) Applicant: Giulio MANZONI, Cremeno (IT)

(72) Inventor: Giulio Manzoni, Cremeno (Lecco) (IT)

(21) Appl. No.: 14/763,889

(22) PCT Filed: Feb. 21, 2014
(86) PCT No.: PCT/EP2014/053402

§ 371 Date: Jul. 28, 2015

(30) Foreign Application Priority Data
Feb. 25, 2013 (IT) CO2013A 000005

(51) Int. Cl. E05D 11/00

(52) U.S. Cl. CPC E05D 11/0054; E05D 2011/0063; E05D 2011/0072

(57) ABSTRACT

The shell having at least two elements, totally encloses a hinge for furniture and has a female element (1) applicable to one of the movable (5) or fixed (9) parts of the hinge for furniture and a fixed male element (7) applicable on the other of the fixed (9) or movable (5) parts of the hinge for furniture, the female element (1) is hingedly connectable to a joint (3) integral with the movable (5) or fixed (9) part of the hinge for furniture or directly with the part of the piece of furniture on which the respective movable (5) or fixed (9) part of the hinge is fixed, biasing or guiding means being provided by means of which the female element (1), during the movement of 10 the hinge, is biased or guided in such a way to slide over the male element (7) secured to the other fixed (9) or movable (5) part of the hinge for furniture.

The present invention relates to a shell having at least two elements and which totally encloses a hinge for furniture. More in particular, the present invention relates to a shell having at least two elements totally enclosing a hinge for furniture, which consists of a female element integral with one of the movable or fixed parts of the hinge for furniture, and a fixed male element applicable on the other of the fixed or movable parts of the hinge for furniture.

The above-described invention aims to resolve, in a novel and original manner, a problem that has not yet been addressed in the furniture industry, namely, that of totally enclosing an aesthetically unattractive hinge for furniture in a shell with its own kinematic mechanism, so as to conceal and replace the limited aesthetic appeal of the hinge with that of a shell that can be shaped as desired. Up to now the problem has not been addressed in the manner in which it is addressed and resolved by the device according to the present invention, and the solutions proposed to date have regarded simple “protective” guards which partially cover hinges for furniture in appropriate points considered to be dangerous, in order to prevent accidents from occurring during the use thereof Other known devices have been proposed solely as simple guards designed to enable the doors and sides of the furniture to be painted with the hinges fitted, without causing damage to the hinges themselves. The object of the present invention is to remedy these and other drawbacks by realizing a shell having at least two elements, one of them fixed and the other one movable, where the movable element slides over the fixed one during closing and opening of the hinge, enclosing it completely, so that the hinge itself is never visible. A further object of the present invention is to realize a shell enclosing a hinge and composed of two elements, one of them fixed and the other one movable, where the movable one is connected in a suitable manner, either directly or indirectly, to the door or body of the piece of furniture and slides over the fixed one, applied, respectively, to the other part of the piece of furniture, according to the reciprocal sections and the constant overlap of the female on the male. A further object of the present invention is to realize a shell where the presence of elements totally enclosing a hinge makes it possible to lend a desired aesthetic appearance to the technical object, i.e. hinge, enclosed therein, since said elements, as they only need to enclose the hinge, have their own kinematic mechanism and can thus take on shapes that differ considerably from those of the hinge they enclose; this makes it possible to realize shells in a whole variety of shapes, provided that the enclosed hinge is invisible. A further object of the present invention is to realize a shell enclosing a hinge with a kinematic mechanism that is totally unlinked from that of the hinge, so that it is possible to have shells in a whole variety of shapes and thicknesses, each applicable to any type of hinge to be enclosed, but with a single assembly system. Yet a further object of the present invention is to realize a shell enclosing a hinge, with a kinematic mechanism that is totally unlinked from that of the hinge, so as to enable the use thereof also in the presence of hinges and bases of different sizes.

These and other objects are achieved by the shell having at least two elements, according to the invention, which totally encloses a hinge for furniture, wherein the female element is hingedly connectable to a joint integral with the movable or fixed part of the hinge for furniture or directly with the part of the piece of furniture to which the respective movable or fixed part of the hinge is fixed and wherein biasing or guiding means are provided by means of which the female element, during the movement of the hinge itself, is biased or guided in such a way as to slide over the male element secured to the other fixed or movable part of the hinge for furniture.

Conveniently, the male element can overlap a third element of the shell, which is upwardly open and downwardly shaped; it encloses the extra part of hinge that is not covered by the male element and is snap-hookable to the same hinge part to which the male element is fixed. This makes it possible to conceal the thicknesses arising from the application of bases of various heights or the use of hinges with arms of different shapes and sizes. In a preferred embodiment, the female element is biased by a spring element so as to rest on the male element.

Conveniently, the female element can be snap-hooked to a block hinged to the joint integral with the movable or fixed part of the hinge for furniture. In a further preferred embodiment the fixed male element is snap-assemblable to the fixed or movable hinge part by means of a wedge block securable thereto. Conveniently, according to the present invention the female element and male element are mutually separate elements that can be secured autonomously to the respective movable or fixed hinge parts.

In a further embodiment of the invention, on either side of the male element there is a suitable lateral protrusion, which, when the hinge is open, fits into a suitable cavity formed within the wall thickness of the female element in such a way to avoid an accidental opening, while the sliding of the female over the male element can be obtained by means of guides or guaranteed by the constant overlap of the female element on the male element itself, in relation to both the respective sections and the action of the closing spring, which on the one hand acts on a joint integral with the movable part of the hinge, or the door, and on the other hand on the shaped shell-supporting block to which the female element is snap-hooked. Moreover, between said shells it is possible to interpose a suitably shaped element, made of an appropriate material and in an appropriate thickness, partially or totally integral with or coupled with the female element, which reduces the possible friction and consequent dragging noise. Furthermore, the presence of the shell-supporting block and wedge block, as components in themselves, rather than enclosed in the respective shells, fulfils the need to be able to have shells of varying shape and thickness, according to the type of hinge to be enclosed, but with a single assembly system. Finally, the presence of shells totally enclosing a hinge makes it possible to lend the desired aesthetic appearance to the technical object, i.e. hinge, which is enclosed therein, since as said shells do not have to support the movement of the door, but only enclose the hinge, they have their own kinematic mechanism and can therefore take on shapes that differ considerably from those of the hinge they enclose; this makes it possible to realize shells in a whole variety of shapes provided that the enclosed hinge is invisible. All this can be achieved with simple, practical and safe movements.

These, as well as further features of the shell having at least two elements, which totally encloses a hinge for furniture, and is the subject matter of the present invention, will be more apparent from the description that follows of preferred, non-limiting embodiments, provided with reference to the 2 appended drawings which schematically illustrate:

Drawing 1:

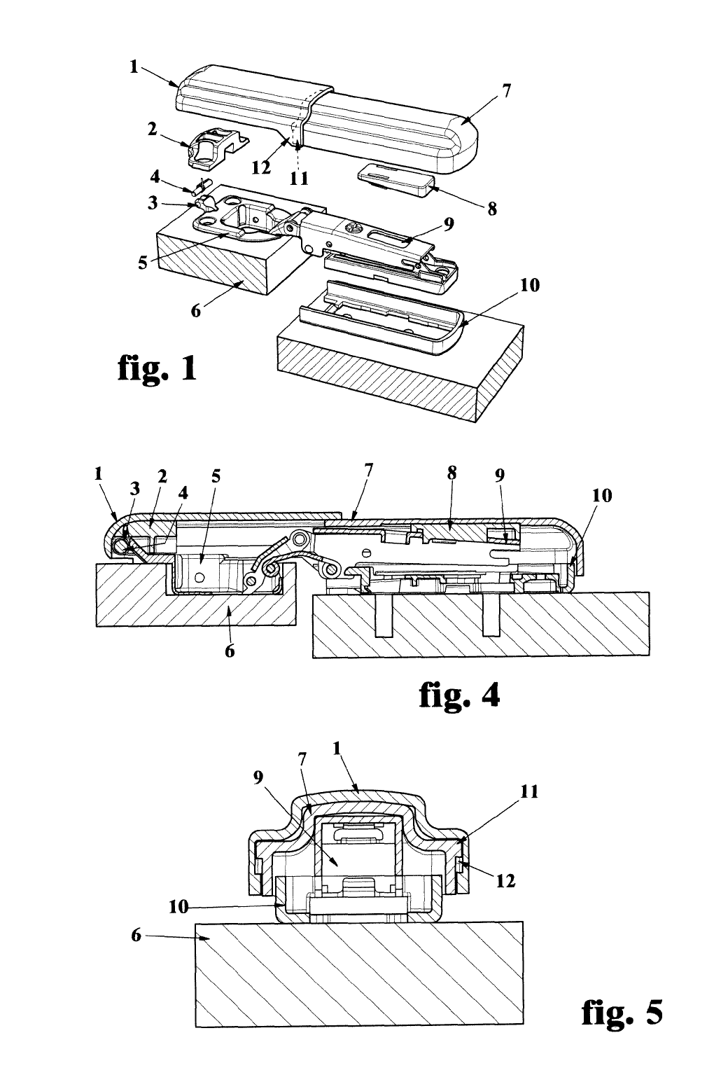

FIG. 1: an exploded view of the invention.

FIG. 2: the invention in an open position.

FIG. 3: the invention in a closed position.

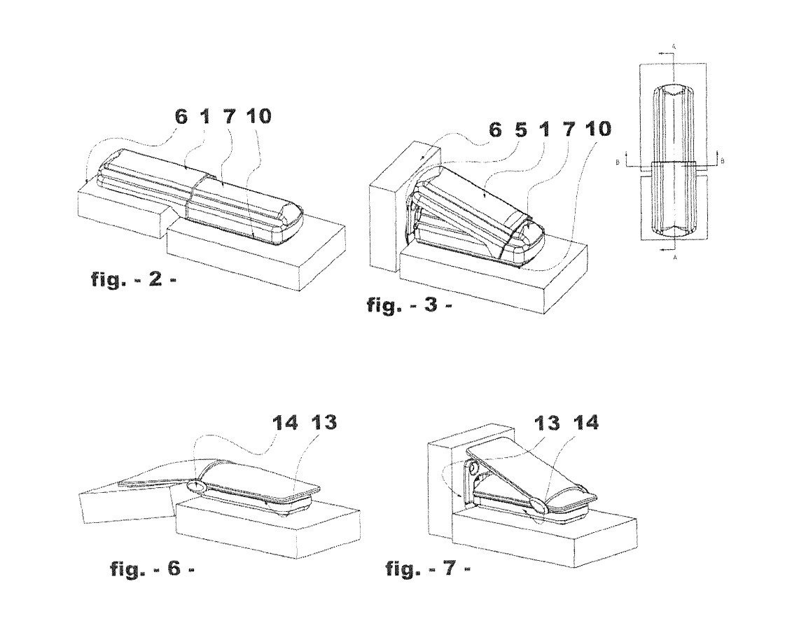

FIG. 4: longitudinal section view of the invention.

FIG. 5: cross section view of the invention.

FIG. 6: the invention in an open position without closing spring.

FIG. 7: the invention in a closed position without closing spring.

Drawing 2:

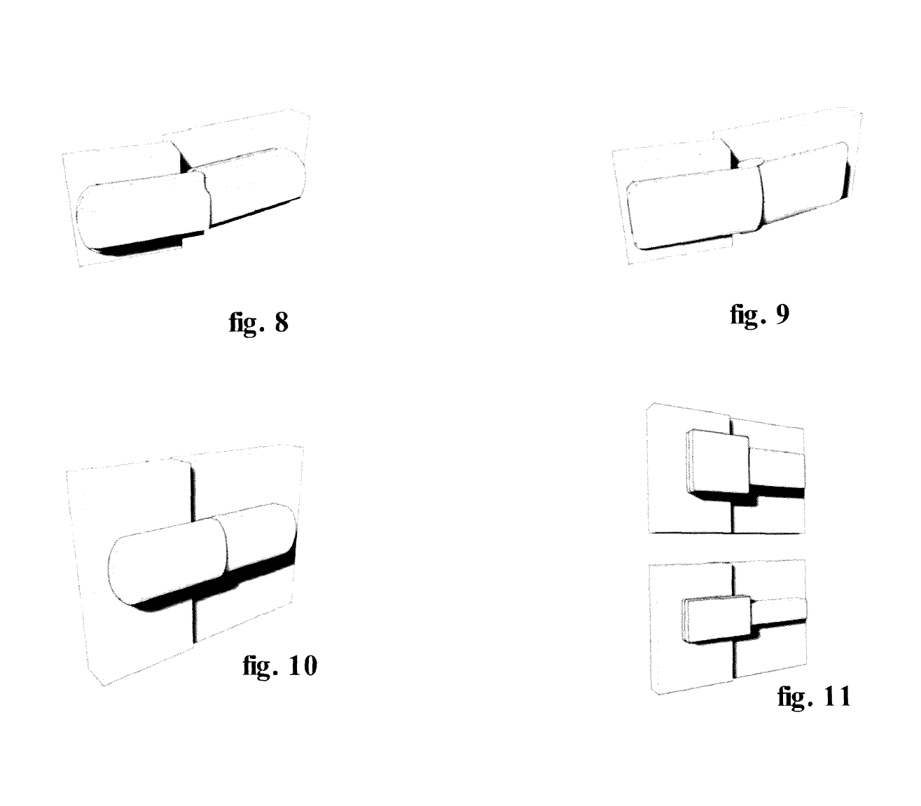

FIGS. 8, 9, 10 and 11: examples of aesthetic appearances of the invention.

It is noted that the colours of the drawings are not binding and have the sole purpose of better explaining the drawings themselves.

With reference to the aforesaid figures, the shell having at least two elements, which totally encloses a hinge for furniture, according to the invention, basically features: a female element 1, suitably and variously shaped, which is snap-hookable to a shell-supporting block 2 hinged onto a joint 3 with a closing spring 4, integral with the movable part of the hinge for furniture 5 or directly with the door 6, as well as a fixed male element 7 snap-assembled by means of a wedge block 8, integral therewith, to the fixed part of the hinge for furniture 9; the female element 1, with a closing spring, slides over the male part 7 during the movement of the hinge 5-9, which, when open, is totally enclosed within the male 7 and female 1 shells, even in the presence of bases or arms of the hinge which vary the thickness thereof, since the male element 7 overlaps, in such a case, a third element of the shell 10, upwardly open and downwardly shaped, which encloses the extra thickness of the fixed hinge 9 and is snap-fit to the hinge itself 9; moreover, on the male element 7 there is a suitable lateral protrusion 11 which, when the hinge 5-9 is open, fits into a suitable cavity 12 fashioned within the wall thickness of the female element 1 so as to prevent an accidental opening thereof, while the sliding of the female 1 over the male 7 does not require guides, being guaranteed by the constant overlap of the female 1 on the male 7 itself, as a result both of their reciprocal sections and the operation of the closing spring 4, which on the one hand acts on the joint 3 integral with the movable part of the hinge 5, or on the door 6, and on the other hand on the shaped shell-supporting block 2, to which the female 1 is snap-hooked. Moreover, between said shells (1,7) it is possible to interpose a suitably shaped element (15), which is made of an appropriate material and in an appropriate thickness and partially or totally integral with or hooked onto the female element, which reduces any possible friction and the consequent dragging noise. The presence of the shell-supporting block 2 and the wedge block 8, as separate components, rather than enclosed in the respective shells 1-7, fulfils the need to be able to have shells 1-7 in a whole variety of shapes and thicknesses with a single assembly system, according to the type of hinge to be enclosed, just as the presence of the joint 3 fashioned in the movable part of the hinge 5 is suitable for the configuration of the hinge 5 itself, whereas with other configurations the joint 3 could be separate and directly integral with the door 6. As the kinematic mechanism of the elements of the shell 1-7 is unlinked from that of the hinge 5-9, the use thereof is possible also in the presence of various hinge arms and bases, just as the presence of the third element 10 of the shell fulfils the need to be able to conceal all the thicknesses arising from the application of bases or from the use of hinges with a full or partial arm, using the depth of the overlap between the third element 10 itself and the male element 7 of the shell. Furthermore, the presence of shells 1-7 totally enclosing a hinge makes it possible to lend a desired aesthetic appearance to the technical object, or hinge, enclosed therein, since said shells 1-7, not having to support the motion of the door 6, but only enclose the hinge 5-9, have their own kinematic mechanism and can therefore take on shapes that differ considerably from those of the hinge 5-9 they enclose, thus allowing the possibility of realizing shells in a whole variety of shapes provided that the enclosed hinge is invisible. Finally, in the event that the closing spring 4 is not used, a cavity 13 will be provided in the male element 7, while a protrusion 14 will be provided on the female element 1 and fitted into the aforesaid cavity 13 in such a way to ensure the constant overlap of the female element 1 on the male element 7. The invention, as described above, has been proposed purely by way of example, meaning that it can be susceptible of numerous modifications or variants, all of which falling within the scope of the present invention; if slight or more sophisticated modifications, adjustments and solutions are introduced, the monoblock can have different applications, also in other fields, just as it can be used, within the furniture industry, for other purposes.

1. A shell having at least two elements, which totally enclose a hinge for furniture, the shell comprising:
a female element applicable to one of a movable or a fixed part of the hinge; and
a fixed male element applicable on the other of the fixed or the movable part of the hinge;
wherein the female element is hingedly connectable to a joint integral with the movable or the fixed part of the hinge directly with a part of a piece of furniture on which the respective movable or fixed part of the hinge is fixed, and wherein a biasing or guiding device is provided, wherein the female element, during the movement of the hinge, is biased or guided in such a way to slide over the male element secured to the other of the fixed or the movable part of the hinge.

2. The shell of claim 1, wherein the male element overlaps a third element of the shell, the third element being upwardly open and downwardly shaped, the third element enclosing an extra part of the hinge not covered by the male element, the third element being snap-hookable to the same hinge part to which the male element is secured.

3. The shell of claim 1, wherein the female element is biased by a closing spring so to rest on the male element.

4. The shell of claim 1, further comprising a block, wherein the female element is snap-hookable to the block, the block being hinged to the joint integral with the movable or the fixed part of the hinge.

5. The shell of claim 1, wherein the fixed male element is snap-assembled to the fixed or the movable part of the hinge by a wedge block securable to the respective fixed or movable part of the hinge.

6. The shell of claim 1, wherein the female element and the male element are separate from each other and autonomously securable to their respective movable or fixed part of the hinge.

7. The shell of claim 1, wherein a suitable lateral protrusion is further provided in the male element, which, with the hinge open, is fittable in a suitable cavity provided within a wall thickness of the female element to avoid an accidental opening.

8. The shell of claim 1, wherein guides are unnecessary for a sliding of the female element over the male element, the sliding being guaranteed by a constant overlap of the female element on the male element, and by a biasing of a closing spring acting on the joint integral with the movable or the fixed part of the hinge, or integral with a door of the furniture, or by the closing spring acting on a block, onto which the female element is snap-hookable, the block being hinged to the joint.

9. The shell of claim 1, further comprising a block, wherein the female element is snap-hookable to the block, the block being hinged to the joint integral with the movable or the fixed part of the hinge; wherein the fixed male element is snap-assembled to the fixed or the movable part of the hinge by a wedge block securable to the respective fixed or movable part of the hinge; and wherein the block and the wedge block, instead of being enclosed within the female and the male elements, fulfills a need to have the female and the male elements with different shapes and thicknesses, in relation to a kind of hinge to be enclosed, but with a single assembly system.

10. The shell of claim 1, wherein the joint is provided in the movable part of the hinge and is suitable for a shape of the movable part of the hinge, while with other shapes the joint can be separate and directly integral with a door of the furniture.

11. The shell of claim 1, wherein a kinematic mechanism of the female and the male elements is unlinked from that of the movable and the fixed part of the hinge.

12. The shell of claim 2, wherein the third element fulfills a need to capably conceal all thicknesses arising from a use of bases or hinges having a partial or full arm, using a depth of an overlap between the third element and the male element.

13. The shell of claim 1, wherein a cavity is provided in the male element, while a protrusion is provided on the female element and fitted in the cavity in such a way to ensure a constant overlap of the female element on the male element.

14. The shell of claim 1, wherein a kinematic mechanism of the female and the male elements is unlinked from that of the movable and the fixed parts of the hinge, wherein the male and the female elements can assume different shapes making possible any desired aesthetic appearance of the movable and the fixed parts of the hinge enclosed in the female and the male elements.

15. The shell of claim 1, further comprising a friction reducing element located between the female element and the male element, the friction reducing element suitably shaped element, made of an appropriate material, and having appropriate thickness, to partially or totally integral with or hook to the female element, the friction reducing element therein reducing possible friction and consequent dragging noise.
